(19) United States
(12) Patent Application Publication
(10) Pub. No.: US 2026/0358553 A1
(43) Pub. Date: Nov. 12, 2026

(54) POLARIZATION MAINTAINING OPTICAL FIBER AND METHOD FOR MANUFACTURING POLARIZATION MAINTAINING OPTICAL FIBER

(71) Applicant: SUMITOMO ELECTRIC INDUSTRIES, LTD., Osaka (JP)

(72) Inventors: Haruki KITAO, Osaka (JP); Tetsuya NAKANISHI, Osaka (JP); Shuhei TOYOKAWA, Osaka (JP)

(21) Appl. No.: 19/109,235

(22) PCT Filed: Jul. 14, 2023
(86) PCT No.: PCT/JP2023/026095

§ 371 Date: Mar. 6, 2025

(30) Foreign Application Priority Data
Sep. 7, 2022 (JP) 2022-142279

(51) Int. Cl. G02B 6/024; C03B 37/027; G02B 6/02; G02B 6/036

(52) U.S. Cl. CPC G02B 6/024; C03B 37/027; G02B 6/02004; G02B 6/0365; G02B 6/03694; C03B 2205/12

(57) ABSTRACT

A polarization maintaining optical fiber of the present disclosure comprises: a core; a pair of stress application portions; one or more low refractive index portions; and a common cladding, the stress application portions, and the low refractive index portions. The common cladding is disposed between the stress application portions and the core, the stress application portions are disposed in a state of being away from the core, the common cladding is disposed between the low refractive index portions, the low refractive index portions are disposed away from each other, the common cladding is disposed between the low refractive index portions and the core, the common cladding is disposed between the low refractive index portions and the stress application portions, and the low refractive index portions are disposed in a state of being away from the core and the stress application portions.

### TECHNICAL FIELD

The present disclosure relates to a polarization maintaining optical fiber and a method for manufacturing a polarization maintaining optical fiber. This application claims priority from Japanese Patent Application No. 2022-142279 filed on Sep. 7, 2022, the content of which is relied upon and incorporated herein by reference in its entirety.

### BACKGROUND ART

A polarization maintaining optical fiber is used to connect optical devices having polarization dependence in an optical transmission/reception system. In recent years, there has been an increasing need for miniaturization of modules and the like including optical devices, and the use of a polarization maintaining optical fiber with a small bend radius is demanded.

For example, a polarization maintaining optical fiber disclosed in Patent literature 1 includes a core, a first cladding coat surrounding the core, a second cladding coat surrounding the first cladding coat and having a low refractive index and functioning as a trench, a third cladding coat surrounding the second cladding coat, and a pair of stress application portions disposed so as to sandwich the core. The radius ratio r2/r1 of the first cladding coat and the second cladding coat is 2.5 to 4.5. A refractive index volume V of the second cladding coat is 25 μm²·% to 110 μm²·%. The pair of stress application portions are arranged so as to physically divide the second cladding coat. In the polarization maintaining optical fiber of Patent literature 1, the second cladding coat doped with F (fluorine) is provided to function as a trench, and thus the difference between the refractive index of the second cladding coat and the refractive index at the outer edge of a mode field diameter (hereinafter, referred to as “MFD”) increases. Thus, the polarization maintaining optical fiber of Patent literature 1 can reduce a bend loss without reducing the MFD when bent to a small radius, as compared with a polarization maintaining optical fiber to which a trench corresponding to the second cladding coat is not applied.

### CITATION LIST

### Patent Literature

Patent literature 1: US 2015/0268413 A1

### SUMMARY OF INVENTION

A polarization maintaining optical fiber of the present disclosure includes a core extending along a fiber axis, a pair of stress application portions, one or a plurality of low-refractive-index portions, and a common cladding surrounding the core, the pair of stress application portions, and the one or each of the plurality of low-refractive-index portions. On a cross-section of the polarization maintaining optical fiber orthogonal to the fiber axis, the common cladding is disposed between each of the pair of stress application portions and the core. The pair of stress application portions are disposed one each on two sides of the core in a state of being away from the core. The common cladding is disposed between the plurality of low-refractive-index portions. The plurality of low-refractive-index portions are disposed in a state of being away from each other. The common cladding is disposed between the one or each of the plurality of low-refractive-index portions and the core. The common cladding is disposed between the one or each of the plurality of low-refractive-index portions and each of the pair of stress application portions. The one or the plurality of low-refractive-index portions are disposed around the core in a state of being away from both the core and the pair of stress application portions.

### BRIEF DESCRIPTION OF THE DRAWINGS

FIG. 1 is a diagram for explaining the structure of a polarization maintaining optical fiber of the present disclosure.

FIG. 2 is a diagram showing various arrangement patterns of low-refractive-index portions on a cross-section of the polarization maintaining optical fiber of the present disclosure.

FIG. 3 is a diagram for explaining an arrangement condition of the low-refractive-index portion on the cross-section of the polarization maintaining optical fiber of the present disclosure.

FIG. 4 is a diagram for explaining a method for manufacturing an optical fiber preform for obtaining the polarization maintaining optical fiber of the present disclosure.

FIG. 5 is a diagram showing a configuration of a drawing apparatus for obtaining the polarization maintaining optical fiber of the present disclosure.

FIG. 6 is a graph showing a dependency of a cutoff wavelength Acc and a bend loss of the polarization maintaining optical fiber of the present disclosure with respect to a refractive index volume V.

FIG. 7 is a graph showing the dependency of the bend loss and the cutoff wavelength of the polarization maintaining optical fiber of the present disclosure with respect to various MFDs at a wavelength of 1.31 μm.

FIG. 8 is a graph showing the dependency of the radius and relative refractive index difference of the core of the polarization maintaining optical fiber of the present disclosure with respect to various MFDs at a wavelength of 1.31 μm.

### DETAILED DESCRIPTION

### Problems to Be Solved by Present Disclosure

The inventors have studied the above-described conventional techniques and have found the following problems. That is, the polarization maintaining optical fiber of Patent literature 1 includes a core, a first cladding coat, a second cladding coat doped with F, a third cladding coat, and a pair of stress application portions. In the polarization maintaining optical fiber, the pair of stress application portions are arranged so that each physically divides the second cladding coat. In manufacturing a preform, first, a through hole is formed in the center of an F-doped rod to become the second cladding coat after drawing, a core rod composed of a core portion and a first cladding portion to become the core and the first cladding coat after drawing is inserted into the through hole of the F-doped rod, and these are integrated to obtain a first intermediate preform constituted by the core portion, the first cladding portion, and the second cladding portion. Next, a through hole is formed in the center of a third cladding portion as a jacket material to become a third cladding coat after drawing, the first intermediate preform is inserted into the through hole of the third cladding portion, and these are integrated to obtain a second intermediate preform constituted by the core portion and the first to third cladding portions. A pair of through holes are formed at predetermined positions in the obtained second intermediate preform, a pair of stress application rods to become a pair of stress application portions after drawing are inserted into each of the pair of through holes, and these are integrated to obtain an optical fiber preform for obtaining a polarization maintaining optical fiber. As described above, in order to obtain the polarization maintaining optical fiber of Patent literature 1, the number of steps required to complete the optical fiber preform is large and complicated, and most of the expensive F-doped rod is discarded in manufacturing the first intermediate preform and inserting the pair of stress application rods, which hinders effective use of the material. This may lead to an increase in manufacturing cost and a decrease in production efficiency.

The present disclosure has been made to solve the above-described problems, and an object of the present disclosure is to provide a polarization maintaining optical fiber having a structure that can be easily manufactured to reduce a bend loss when bent to a small radius, and a method for manufacturing the polarization maintaining optical fiber.

### Advantageous Effects of Present Disclosure

According to the present disclosure, a polarization maintaining optical fiber having a structure for reducing bend loss when bent to a small radius is obtained.

### Description of Embodiments of Present Disclosure

First, the contents of embodiments of the present disclosure will be described by listing them individually.
(1) A polarization maintaining optical fiber of the present disclosure includes a core extending along a fiber axis, a pair of stress application portions, one or a plurality of low-refractive-index portions, and a common cladding surrounding the core, the pair of stress application portions, and the one or each of the plurality of low-refractive-index portions. On a cross-section of the polarization maintaining optical fiber orthogonal to the fiber axis, the common cladding is disposed between each of the pair of stress application portions and the core. The pair of stress application portions are disposed one each on two sides of the core in a state of being away from the core. The common cladding is disposed between the plurality of low-refractive-index portions. The plurality of low-refractive-index portions are disposed in a state of being away from each other. The common cladding is disposed between the one or each of the plurality of low-refractive-index portions and the core. The common cladding is disposed between the one or each of the plurality of low-refractive-index portions and each of the pair of stress application portions. The one or the plurality of low-refractive-index portions are disposed around the core in a state of being away from both the core and the pair of stress application portions.

As described above, one or the plurality of low-refractive-index portions disposed around the core with a space therebetween and arranged with a space between each of the pair of stress application portions function as a trench layer disposed around the core. Thus, the polarization maintaining optical fiber provided with the low-refractive-index portion achieves a reduction in a bend loss when bent to a small radius. Further, since each of low-refractive-index portions is not in contact with the pair of stress application portions, the complexity of the element arrangement in the fiber cross-section is avoided, the number of manufacturing steps is small, and the manufacturing cost can be reduced.
(2) In the above (1), on the cross-section of the polarization maintaining optical fiber, a contour of the one or each of the plurality of low-refractive-index portions may have a shape constituted by only a straight line or straight lines, by only a curved line or curved lines, or by a combination of a straight line or straight lines and a curved line or curved lines. Specifically, the contour of each low-refractive-index portion is formed by all figures constituted by at least one of a straight line, straight lines, a curved line and curved lines, such as a circle, an ellipse, a rectangle, and a triangle. As described above, in the polarization maintaining optical fiber of the present disclosure, the shape of the cross-section of each low-refractive-index portion is not limited as long as the cross-section of each low-refractive-index portion is not in contact with the stress application portion.
(3) In the above (1) or (2), the polarization maintaining optical fiber may include two to six low-refractive-index portions as the one or the plurality of low-refractive-index portions. On the cross-section, the two to six low-refractive-index portions may be disposed at respective positions at which center-to-center distances of the two to six low-refractive-index portions from a center of the core are equal to each other, and the two to six low-refractive-index portions may be disposed not to overlap either of the pair of stress application portions. Here, when the cross-section of each low-refractive-index portion is circular, the preform can be manufactured by collapsing a common cladding rod in which a columnar low-refractive-index rod is inserted into a through hole. Thus, the polarization maintaining optical fiber of the present disclosure can be manufactured at low cost. The low-refractive-index rod is a member that is to become the low-refractive-index portion after drawing, and the common cladding rod is a member that is to be the common cladding after drawing. When the number of low-refractive-index portions is small, the manufacturing cost for forming through holes into which each of the low-refractive-index rods is inserted is reduced, but confinement of the fundamental mode is weakened, which is a factor of increasing the bend loss. Thus, according to the polarization maintaining optical fiber of the present disclosure, it is important to adjust the number of low-refractive-index portions so that the desired cutoff wavelength and bend loss characteristic can be obtained.

The latest version of the ITU-T standard G.657.B3 was published in November 2016. G657.B3 is described on the latest version page 9, and the MFD at a wavelength of 1310 nm (=1.31 μm) is 8.6 μm to 9.2 μm. However, since the tolerance is ±0.4 μm, the MFD at a wavelength of 1310 nm is substantially 8.2 μm to 9.6 μm. The cutoff wavelength is 1260 nm (=1.26 μm) or less. The bend loss being measured in a state in which the polarization maintaining optical fiber is bent once with a bend radius of 5 mm is 0.15 dB or less at a wavelength of 1550 nm (=1.55 μm).
(4) In any one of the above (1) to (3), on the cross-section of the polarization maintaining optical fiber, each of the pair of stress application portions may have an outside diameter of 30 μm to 40 μm. A relative refractive index difference of each of the pair of stress application portions with respect to the common cladding may be 0.0% or less. That is, the refractive index of each of the pair of stress application portions may be equal to or less than the refractive index of the common cladding. A ratio a/b_SAP (hereinafter, referred to as “Ra_SAP”) of a radius a of the core to a shortest distance b_SAP from a center of the core to a contour of each of the pair of stress application portions may be 0.4 to 0.6. When the outside diameter of each of stress application portions is less than 30 μm or more than 40 μm, the birefringence in the core is reduced, and polarization maintaining characteristics are degraded. Further, when Ra_SAP is less than 0.4 and the shortest interval from the center of the core to the contour of each stress application portion is large, the birefringence in the core is also reduced. On the other hand, when Ra_SAP is larger than 0.6, the through hole for inserting a stress application rod and the through hole for inserting a core rod, which are provided in the common cladding rod to become the common cladding at the time of manufacturing the preform, are close to each other, and thus it is difficult to manufacture the preform. The stress application rod is a member to become one of the pair of stress application portions after drawing, and the core rod is a member to become the core after drawing. In addition, each stress application portion also contributes to a reduction in the bend loss, and in particular, when the polarization maintaining optical fiber is bent such that the center of each stress application portion is in a 0 degree direction, that is, each stress application portion is parallel to a bent surface, the bend loss is greatly reduced. Here, the bent surface is a plane for indicating a bending direction of the polarization maintaining optical fiber, and includes a central axis of the polarization maintaining optical fiber in a bent state.
(5) In any one of (1) to (4), on the cross-section of the polarization maintaining optical fiber, a refractive index volume V may be 20 μm²·% to 120 μm²·%, the refractive index volume V being defined by a product of a total area of the one or the plurality of low-refractive-index portions and an absolute value of an average value of relative refractive index differences of the one or the plurality of low-refractive-index portions. By appropriately selecting the refractive index volume V, a polarization maintaining optical fiber conforming to the ITU-T standard G.657.B3 is obtained.
(6) In any one of the above (1) to (5), the polarization maintaining optical fiber may have a mode field diameter of 8.2 μm to 10.2 μm at a wavelength of 1.31 μm, a bend loss of less than 0.15 dB at a wavelength of 1.55 μm, the bend loss being measured in a state in which the polarization maintaining optical fiber is bent once with a bend radius of 5 mm such that each of the pair of stress application portions is parallel to a bent surface, and a cutoff wavelength of less than 1.26 μm. When the refractive index volume V is less than 20 μm²·%, a bending resistance is low, and the bend loss at a wavelength of 1.55 μm exceeds 0.15 dB. On the other hand, when the refractive index volume V exceeds 120 μm²·%, the interval between the low-refractive-index portions is narrow in the case where six low-refractive-index portions are arranged, and it is difficult to form a through hole in manufacturing the preform. The cutoff wavelength and the bend loss are in a trade-off relationship, and the allowable width (tolerance) of a structure satisfying the ITU-T standard G.657.B3 depends on the MFD.
(7) In any one of the above (1) to (6), on the cross-section of the polarization maintaining optical fiber, the core may have a radius of 3 μm to 5 um, and a relative refractive index difference of the core with respect to the common cladding may be 0.2% to 0.5%. It is sufficient that the relative refractive index difference of one or the plurality of low-refractive-index portions with respect to the common cladding is −1.0% to −0.5%. The core radius and the relative refractive index difference of the core are appropriately selected from these ranges, and thereby the MFD described in the above (6) is realized.
(8) A method for manufacturing a polarization maintaining optical fiber that is the polarization maintaining optical fiber according to any one of claim 1 to claim 7 of the present disclosure includes manufacturing an optical fiber preform for obtaining the polarization maintaining optical fiber, and drawing the optical fiber preform manufactured in the manufacturing of the optical fiber preform. The manufacturing of the optical fiber preform includes preparing a common cladding rod to become part of the common cladding after drawing and individually performing preparation of a core rod including a portion to become the core after drawing, preparation of one or a plurality of low-refractive-index rods to become the one or the plurality of low-refractive-index portions after drawing, and preparation of a pair of stress application rods to become the pair of stress application portions after drawing. That is, the performing preparation of the core rod, the performing preparation of one or the plurality of low-refractive-index rods, and the performing preparation of the pair of stress application rods do not need to be performed concurrently. The manufacturing of the optical fiber preform includes individually performing, with respect to the common cladding rod, formation of a first through hole into which the core rod is to be inserted, formation of one or a plurality of second through holes into which the one or the plurality of low-refractive-index rods are to be individually inserted, and formation of a pair of third through holes into which the pair of stress application rods are to be individually inserted. That is, the performing formation of the first through hole, the performing formation of the second through hole, and the performing formation of the third through hole do not need to be performed concurrently. The manufacturing of the optical fiber preform includes individually performing integration of the common cladding rod and the core rod, integration of the common cladding rod and the one or the plurality of low-refractive-index rods, and integration of the common cladding rod and the pair of stress application rods. That is, the performing integration of core rod integration, the performing integration of low-refractive-index rod integration, and the performing integration of stress application rod integration need not be performed concurrently.

In the optical fiber preform, the common cladding rod is disposed among the core rod, the one or each of the plurality of low-refractive-index rods, and each of the pair of stress application rods. In the manufacturing method of Patent literature 1, it is necessary to remove a part of the trench layer formed previously in order to provide a pair of stress application portions. On the other hand, according to the manufacturing method of the present disclosure, the manufacturing steps are simplified and it is not necessary to remove the trench layer once formed, as compared with the manufacturing method of Patent literature 1, and thus, cost reduction is expected from the viewpoint of the manufacturing steps. Further, according to the manufacturing method of the present disclosure, a low bend loss polarization maintaining optical fiber conforming to ITU-T Standard G.657.B3 can be obtained.

Each of the aspects listed in the “Description of Embodiments of Present Disclosure” section above is applicable to each of the remaining aspects or to all combinations of these remaining aspects.

### Details of Embodiments of Present Disclosure

Hereinafter, a polarization maintaining optical fiber and a method for manufacturing a polarization maintaining optical fiber according to the present disclosure will be described in detail with reference to the accompanying drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description thereof will be omitted.

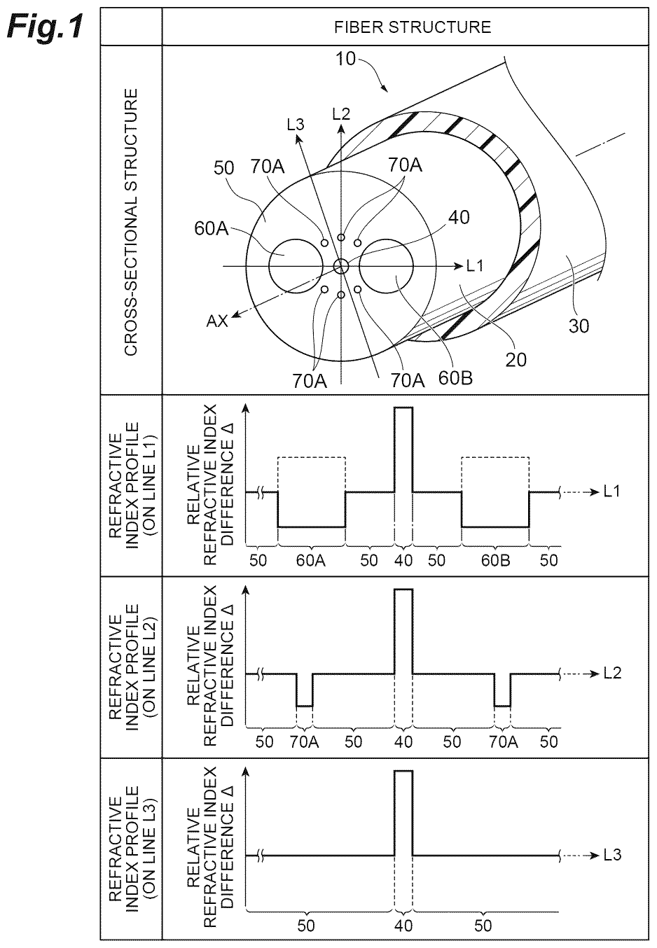

FIG. 1 is a diagram for explaining the structure of a polarization maintaining optical fiber of the present disclosure (in FIG. 1, referred to as “fiber structure”). An example of a cross-sectional structure of a polarization maintaining optical fiber 10 of the present disclosure is shown in the uppermost row of FIG. 1 (in FIG. 1, referred to as “cross-sectional structure”). The second row of FIG. 1 (in FIG. 1, described as “refractive index profile (on a line L1)”) shows the refractive index profile along line L1 in the cross-section of polarization maintaining optical fiber 10 in the uppermost row. The third row of FIG. 1 (in FIG. 1, described as “refractive index profile (on a line L2)”) shows the refractive index profile along line L2 in the cross-section of polarization maintaining optical fiber 10 in the uppermost row. The lowermost row of FIG. 1 (in FIG. 1, described as “refractive index profile (on a line L3)”) shows the refractive index profile along line L3 in the cross-section of polarization maintaining optical fiber 10 in the uppermost row.

As shown in the uppermost row of FIG. 1, polarization maintaining optical fiber 10 of the present disclosure includes a glass optical fiber 20 containing silica glass as a main component, and a resin coat 30 provided on the outer peripheral surface of glass optical fiber 20. Glass optical fiber 20 includes a core 40 extending along a fiber axis AX, a common cladding 50, a pair of stress application portions 60A and 60B arranged to sandwich core 40 with a space from core 40, and one or a plurality of low-refractive-index portions 70A arranged to surround core 40 and to be spaced apart from both core 40 and the pair of stress application portions 60A and 60B.

The refractive index profile shown in the second row of FIG. 1 is given by the relative refractive index difference at each portion along line L1 passing through the center of core 40 and the centers of the pair of stress application portions 60A and 60B, as shown in the uppermost row of FIG. 1, in the cross-section of polarization maintaining optical fiber 10 orthogonal to the fiber axis AX. Core 40 has a radius of 3 μm to 5 μm. The relative refractive index difference of core 40 with respect to common cladding 50 is 0.2% to 0.5%. Each of the pair of stress application portions 60A and 60B has an outside diameter of 30 μm to 40 μm. The relative refractive index difference of each of the pair of stress application portions 60A and 60B with respect to common cladding 50 is 0.0% or less. In addition, each of the pair of stress application portions 60A and 60B may have a positive relative refractive index difference with respect to common cladding 50 as indicated by a dashed line.

The refractive index profile shown in the third row of FIG. 1 is given by the relative refractive index difference at each portion along line L2 passing through the center of core 40 and the center of any one of low-refractive-index portions 70A, as shown in the uppermost row of FIG. 1, in the cross-section of polarization maintaining optical fiber 10. The relative refractive index difference of each low-refractive-index portion 70A with respect to common cladding 50 is −1.0% to −0.5%. In this way, one or the plurality of low-refractive-index portions 70A surrounding core 40 function as a trench layer as a whole. With such a structure, polarization maintaining optical fiber 10 provided with one or the plurality of low-refractive-index portions 70A achieves a reduction in a bend loss when bent to a small radius.

The refractive index profile shown in the lowermost row of FIG. 1 is given by the relative refractive index difference at each portion along line L3 passing through the center of core 40 and the middle position of two adjacent low-refractive-index portions 70A, as shown in the uppermost row of FIG. 1, in the cross-section of polarization maintaining optical fiber 10.

As described above, in polarization maintaining optical fiber 10 of the present disclosure, in the cross-section thereof, each of core 40, the pair of stress application portions 60A and 60B, and one or the plurality of low-refractive-index portions 70A are disposed at physically separated positions with a part of common cladding 50 interposed therebetween. Thus, as shown in the second to lowermost rows of FIG. 1, the refractive index profiles of polarization maintaining optical fiber 10 have different shapes when straight lines passing through the center of core 40 are rotated in the circumferential direction of core 40 in the cross-section. Further, since each of low-refractive-index portions 70A is not in contact with the pair of stress application portions 60A and 60B, the complexity of the element arrangement in the cross-section is avoided, the number of manufacturing steps is small, and the manufacturing cost can be reduced.

Furthermore, according to polarization maintaining optical fiber 10 having the above-described structure, by providing the low-refractive-index portion, as in the trench layer in Patent literature 1 described above, the difference between the refractive index of each low-refractive-index portion 70A and the effective refractive index obtained at the outer edge of the MFD is increased, and the bend loss when bent to a small radius can be reduced as compared with a polarization maintaining optical fiber not having a low-refractive-index portion. In addition, the MFD, the bend loss, and the cutoff wavelength can be easily designed to satisfy the ITU-T standard G.657.B3.

By appropriately selecting the diameters of core 40 and the positions and sizes of each low-refractive-index portion 70A and the pair of stress application portions 60A and 60B, the manufacturing cost can be reduced while conforming to the ITU-T standard G.657.b3.

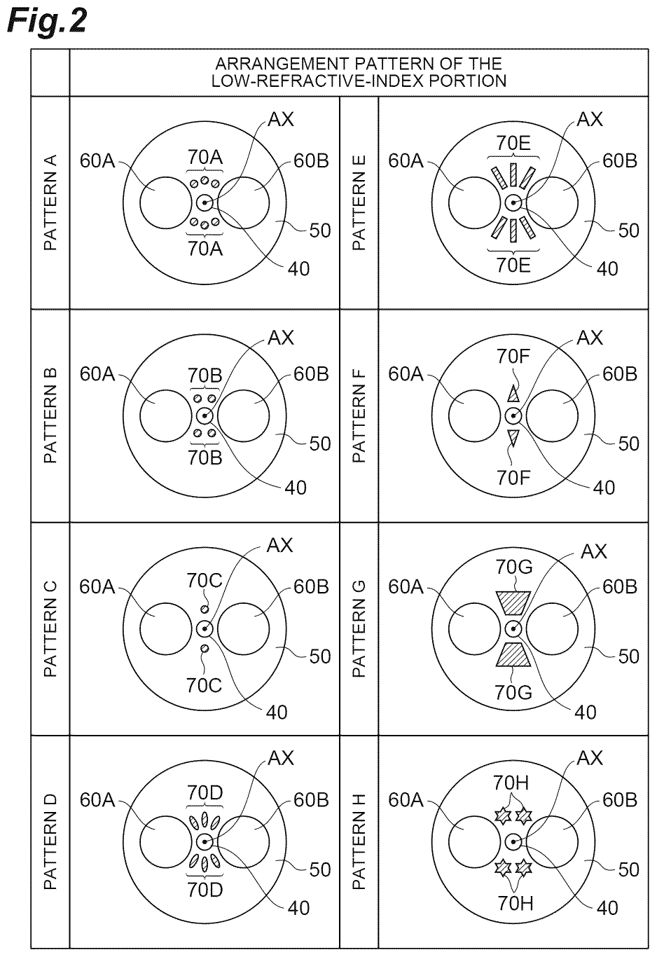

FIG. 2 is a diagram showing various arrangement patterns of the low-refractive-index portion on the cross-section of the polarization maintaining optical fiber of the present disclosure (in FIG. 2, described as “arrangement pattern of the low-refractive-index portion”). Note that patterns A to H shown in FIG. 2 are all arrangement patterns on a cross-section of glass optical fiber 20 orthogonal to the fiber axis AX.

On the cross-section of polarization maintaining optical fiber 10 of the present disclosure, the contour of each low-refractive-index portion may have a shape constituted by only a straight line or straight lines, by only a curved line or curved lines, or by a combination of a straight line or straight lines and a curved line or curved lines. In addition, the cross-sectional shape of the low-refractive-index portion applied to polarization maintaining optical fiber 10 of the present disclosure, which is defined by the contour on the cross-section of polarization maintaining optical fiber 10, is not limited to the shape defined by the contour as long as the low-refractive-index portion is not in contact with the stress application portion as illustrated in FIG. 2.

Specifically, in the pattern A shown in FIG. 2, two groups of low-refractive-index portions are arranged so as not to be in contact with the pair of stress application portions 60A and 60B with core 40 interposed therebetween. Each group of low-refractive-index portions is composed of three low-refractive-index portions 70A each having a contour of a circular shape. In the pattern B shown in FIG. 2, two groups of low-refractive-index portions are arranged as in the pattern A. However, each group of low-refractive-index portions is composed of two low-refractive-index portions 70B each having a contour of a circular shape. In the pattern C shown in FIG. 2, two groups of low-refractive-index portions are arranged as in the patterns A and B. However, each group of low-refractive-index portions is composed of one low-refractive-index portion 70C having a contour of a circular shape.

In the pattern D shown in FIG. 2, two groups of low-refractive-index portions are arranged as in the pattern A, but the shape of the contour of each low-refractive-index portion 70D is non-circular. That is, each group of low-refractive-index portions is composed of three low-refractive-index portions 70D each having a contour of an elliptical shape. Each of the two groups of low-refractive-index portions of the pattern E shown in FIG. 2 is composed of three low-refractive-index portions 70E. The shape of a contour of each low-refractive-index portion 70E is a rectangle. Each of the two groups of low-refractive-index portions of the pattern F shown in FIG. 2 is composed of one low-refractive-index portion 70F. The shape of a contour of each low-refractive-index portion 70F is a triangle. Each of the two groups of low-refractive-index portions of the pattern G shown in FIG. 2 is composed of one low-refractive-index portion 70G. The shape of a contour of each low-refractive-index portion 70G is a trapezoid. Further, each of the two groups of low-refractive-index portions of the pattern H shown in FIG. 2 is composed of two low-refractive-index portions 70H. The shape of a contour of each low-refractive-index portion 70H is a star shape.

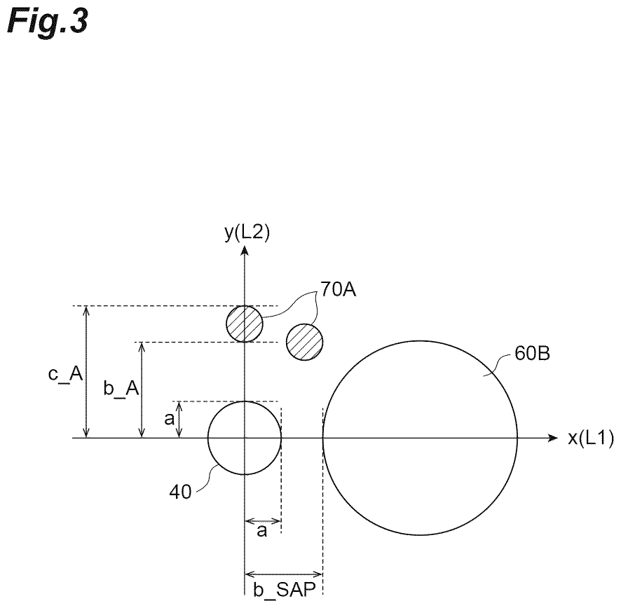

FIG. 3 is a diagram for explaining an arrangement condition of the low-refractive-index portion on the cross-section of polarization maintaining optical fiber 10 of the present disclosure. In the following description, low-refractive-index portion 70A of the pattern A shown in FIG. 2 will be described as a representative example of the low-refractive-index portion.

Further, as shown in FIG. 3, the arrangement of core 40, each low-refractive-index portion 70A, and the pair of stress application portions 60A and 60B on the cross-section of polarization maintaining optical fiber 10 of the present disclosure is defined by an orthogonal coordinate system (x-y coordinate system) with the center of core 40 as an origin. In FIG. 3, an x-axis coincides with line L1 shown in the uppermost row of FIG. 1, and a y-axis coincides with line L2.

The radius of core 40 is a. The shortest distance from the center of core 40 to the contour of each low-refractive-index portion 70A is b_A. The longest distance from the center of core 40 to the contour of each low-refractive-index portion 70A is c_A. In addition, the shortest distance from the center of core 40 to the contour of each of the pair of stress application portions 60A and 60B is b_SAP. In polarization maintaining optical fiber 10 of the present disclosure, a ratio Ra_SAP (=a/b_SAP) of the radius a of core 40 to the shortest distance b_SAP is 0.4 to 0.6. When the outside diameter of each of the pair of stress application portions 60A and 60B is less than 30 μm or more than 40 μm, a birefringence in core 40 is reduced, and polarization maintaining characteristics are degraded. In addition, when Ra SAP is less than 0.4 and the shortest interval from the center of core 40 to the contour of the pair of stress application portions 60A and 60B is large, the birefringence in core 40 is also reduced. On the other hand, when Ra_SAP is larger than 0.6, a through hole for inserting a stress application rod and a through hole for inserting a core rod, which are provided in a common cladding rod to become common cladding 50 at the time of manufacturing the preform, are close to each other, and thus it is difficult to manufacture the preform. The stress application rod is a member to become any one of stress application portions 60A and 60B after drawing, and the core rod is a member to become core 40 after drawing. Further, the pair of stress application portions 60A and 60B also contribute to the reduction in the bend loss. In particular, when polarization maintaining optical fiber 10 is bent such that the centers of the pair of stress application portions 60A and 60B are in a 0 degree direction, that is, each of the pair of stress application portions 60A and 60B is parallel to a bent surface, line L1 passing through the centers of the pair of stress application portions 60A and 60B at each portion along a longitudinal direction of polarization maintaining optical fiber 10 is perpendicular to the bent surface, and the bend loss is greatly reduced.

In addition, polarization maintaining optical fiber 10 of the present disclosure includes two to six low-refractive-index portions, such as low-refractive-index portion 70A to low-refractive-index portion 70H shown in FIG. 2, in order to satisfy the ITU-T standard G.657.B3. In this case, on the cross-section, the two to six low-refractive-index portions are disposed at respective positions at which center-to-center distances of the two to six low-refractive-index portions from a center of core 40 are equal to each other, and the two to six low-refractive-index portions are disposed not to overlap either of the pair of stress application portions 60A and 60B. In addition, when the cross-sectional shape is a circular as in each of low-refractive-index portion 70A to low-refractive-index portion 70C, polarization maintaining optical fiber 10 can be manufactured at low cost. Further, in the process of manufacturing the optical fiber preform, the manufacturing cost associated with the formation of the through hole in the common cladding rod to become common cladding 50 after drawing is reduced. On the other hand, when the number of low-refractive-index portions is small, the confinement of a fundamental mode is weakened, which is a factor of increasing the bend loss. Thus, according to polarization maintaining optical fiber 10 of the present disclosure, it is important to adjust the number of low-refractive-index portions so that desired cutoff wavelength and bend loss characteristics can be obtained.

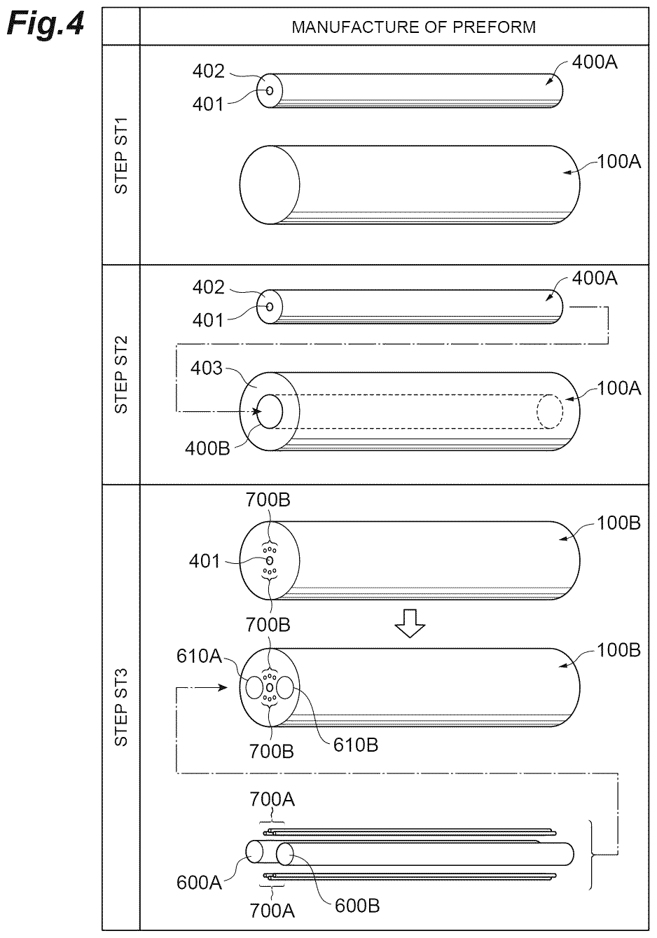

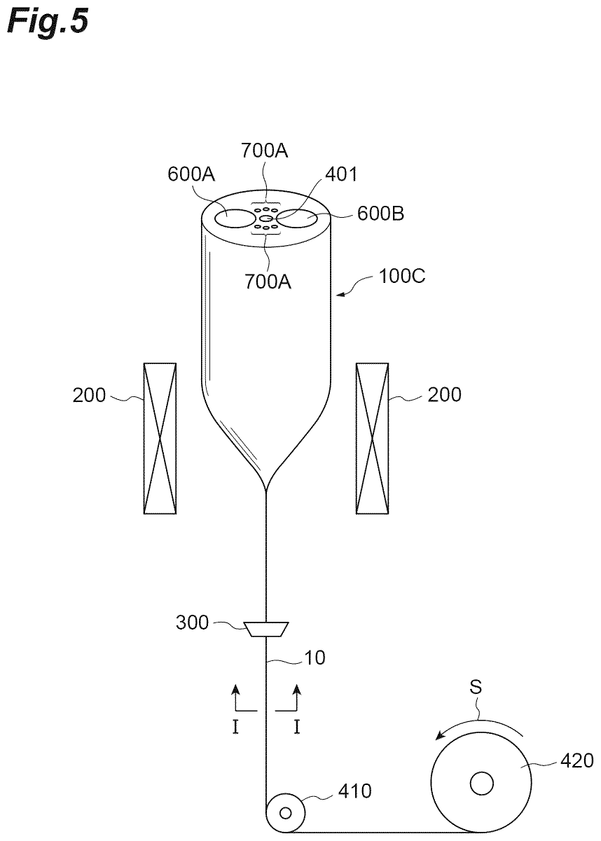

FIG. 4 is a diagram for explaining a method for manufacturing an optical fiber preform 100C for obtaining polarization maintaining optical fiber 10 of the present disclosure (in FIG. 4, described as “manufacture of preform”). FIG. 5 is a diagram showing a configuration of a drawing apparatus for obtaining polarization maintaining optical fiber 10 of the present disclosure. The upper row of FIG. 4 (described as “step ST1” in FIG. 4) shows preparing members constituting an intermediate preform 100B. The middle row of FIG. 4 (described as “step ST2” in FIG. 4) shows manufacturing an intermediate preform in which hole opening, insertion, and sintering are performed for obtaining intermediate preform 100B. The lower row of FIG. 4 (described as “step ST3” in FIG. 4) shows manufacturing the optical fiber preform in which member preparation, hole opening, insertion, and sintering are performed for obtaining optical fiber preform 100C from intermediate preform 100B. In the following description, as in the example of FIG. 3, low-refractive-index portion 70A of the pattern A shown in FIG. 2 will be described as a representative example of the low-refractive-index portion.

The method for manufacturing polarization maintaining optical fiber 10 of the present disclosure includes manufacturing a preform shown in FIG. 4 and drawing shown in FIG. 5. Manufacturing the preform includes a first sub-step to a fourth sub-step for obtaining optical fiber preform 100C. In the first sub-step, a common cladding rod 100A is prepared. Common cladding rod 100A is processed so as to leave a cladding outer side portion 403 to become a physical cladding layer of common cladding 50 after drawing. This physical cladding layer is called a jacket layer.

In the second sub-step, preparation of a core rod 400A, preparation of one or a plurality of low-refractive-index rods 700A, and preparation of a pair of stress application rods 600A and 600B are individually performed. Core rod 400A includes a core portion 401 to become core 40 after drawing at the center of a pure silica rod, and is constituted by core portion 401 and a cladding inner side portion 402 surrounding core portion 401. Cladding inner side portion 402 is a portion to become an optical cladding layer of common cladding 50 after drawing. One or the plurality of low-refractive-index rods 700A are members to become one or the plurality of low-refractive-index portions 70A after drawing. The pair of stress application rods 600A and 600B are members to become the pair of stress application portions 60A and 60B after drawing. Note that the second sub-step for core rod 400A, the second sub-step for one or the plurality of low-refractive-index rods 700A, and the second sub-step for the pair of stress application rods 600A and 600B do not need to be performed concurrently.

In the third sub-step, formation of a first through hole 400B into which core rod 400A is inserted, formation of one or a plurality of second through holes 700B into which one or the plurality of low-refractive-index rods 700A are individually inserted, and formation of a pair of third through holes 610A and 610B into which the pair of stress application rods 600A and 600B are individually inserted are individually performed on common cladding rod 100A. Common cladding rod 100A in which first through hole 400B is formed corresponds to cladding outer side portion 403. The third sub-step for first through hole 400B, the third sub-step for second through hole 700B, and the third sub-steps for third through holes 610A and 610B do not need to be performed concurrently.

In the fourth sub-step, integration of common cladding rod 100A and core rod 400A, integration of common cladding rod 100A and one or the plurality of low-refractive-index rods 700A, and integration of common cladding rod 100A and the pair of stress application rods 600A and 600B are individually performed. The fourth sub-step for core rod integration, the fourth sub-step for low-refractive-index rod integration, and the fourth sub-step for stress application rod integration need not be performed concurrently. The integration of common cladding rod 100A and core rod 400A is realized by collapsing common cladding rod 100A in a state where core rod 400A is inserted into first through hole 400B. Further, cladding inner side portion 402 of core rod 400A and cladding outer side portion 403 of common cladding rod 100A constitute a portion to become common cladding 50 after drawing by integration. The integration of common cladding rod 100A and one or the plurality of low-refractive-index rods 700A is realized by collapsing common cladding rod 100A in a state where one or the plurality of low-refractive-index rods 700A are each inserted into one or the plurality of second through holes 700B. Further, common cladding rod 100A and the pair of stress application rods 600A and 600B are realized by collapsing common cladding rod 100A in a state where the pair of stress application rods 600A and 600B are inserted into the pair of third through holes 610A and 610B.

Note that, after the first sub-step is performed, the second sub-step to the fourth sub-step for core rod 400A, the second sub-step to the fourth sub-step for low-refractive-index rod 700A, and the second sub-step to the fourth sub-step for the pair of stress application rods 600A and 600B may be performed in order. As an example, in manufacturing the preform of FIG. 4, first, the second sub-step to the fourth sub-step for core rod 400A are performed following the first sub-step, and then the second sub-step to the fourth sub-step for both low-refractive-index rod 700A and the pair of stress application rods 600A and 600B are performed.

Specifically, in the step ST1 shown in the upper row of FIG. 4, the first sub-step for common cladding rod 100A and the second sub-step for core rod 400A are performed. That is, in the step ST1, common cladding rod 100A and core rod 400A including core portion 401 and cladding inner side portion 402 are prepared. Subsequently, in the step ST2 shown in the middle row of FIG. 4, the third sub-step and the fourth sub-step for core rod 400A are performed, and intermediate preform 100B is finally obtained. Intermediate preform 100B is common cladding rod 100A in which core rod 400A is integrated, and is composed of cladding inner side portion 402 and cladding outer side portion 403 after the third sub-step.

In the step ST3 shown in the lower row of FIG. 4, as the second sub-step, one or the plurality of low-refractive-index rods 700A and the pair of stress application rods 600A and 600B are further prepared. Subsequently, the third sub-step and the fourth sub-step for one or the plurality of low-refractive-index rods 700A and the third sub-step and the fourth sub-step for the pair of stress application rods 600A and 600B are performed concurrently, and finally optical fiber preform 100C is obtained. Optical fiber preform 100C is common cladding rod 100A in which one or the plurality of low-refractive-index rods 700A and the pair of stress application rods 600A and 600B are integrated in addition to core rod 400A. In optical fiber preform 100C obtained through the first sub-step to the fourth sub-step, common cladding rod 100A is disposed among core rod 400A, each of one or the plurality of low-refractive-index rods 700A, and each of the pair of stress application rods 600A and 600B.

Optical fiber preform 100C manufactured as described above is set in the drawing apparatus shown in FIG. 5, and polarization maintaining optical fiber 10 of the present disclosure is obtained. The drawing apparatus includes a heater 200, a resin coating device 300, a roller 410, and a winding device 420. When winding device 420 rotates in a direction indicated by an arrow S, a glass optical fiber is drawn from one end of optical fiber preform 100C heated by heater 200. The outer circumferential surface of the glass optical fiber is coated with a resin by resin coating device 300, and finally, polarization maintaining optical fiber 10 coated with the resin is wound around a drum of winding device 420 via roller 410. The cross-sectional structure of polarization maintaining optical fiber 10 taken along the line I-I shown in FIG. 5 coincides with the cross-sectional structure shown in the upper row of FIG. 1.

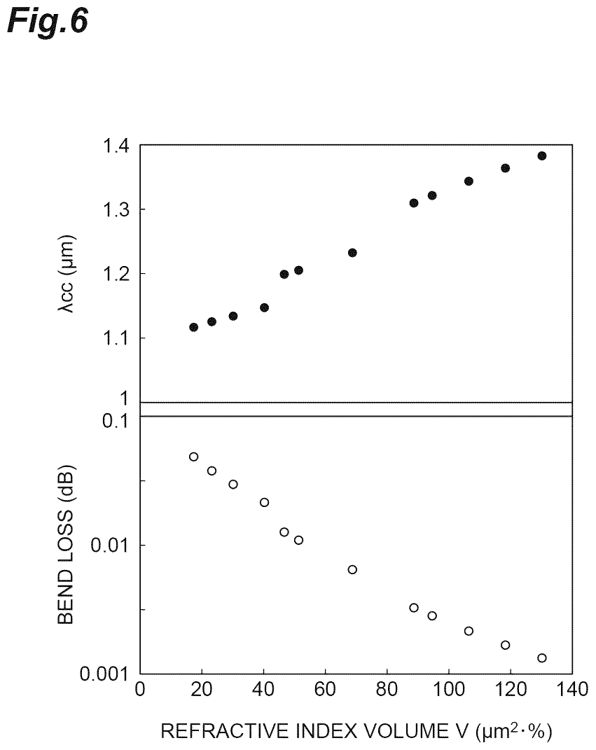

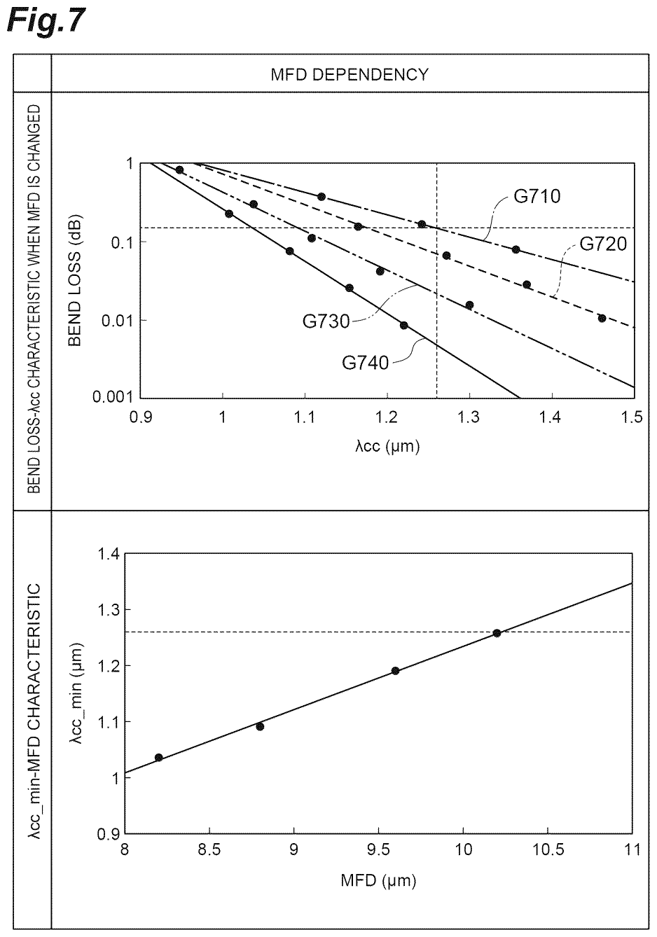

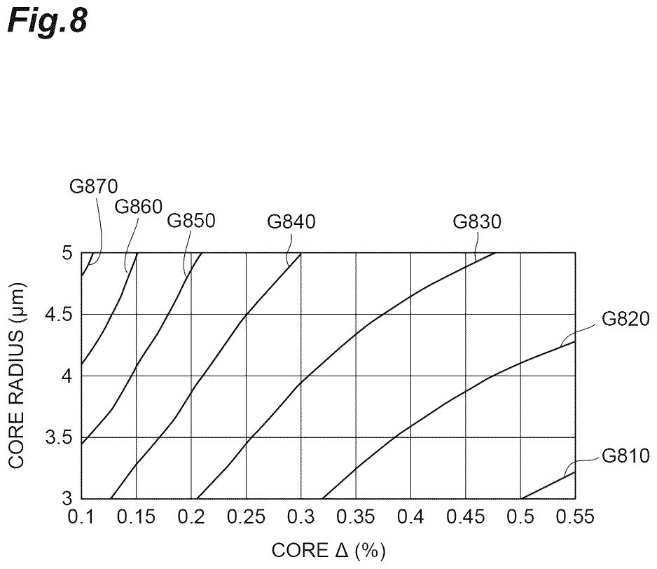

Next, as optical characteristics of the polarization maintaining optical fiber of the present disclosure, the optical characteristics of polarization maintaining optical fiber 10 having the cross-sectional structure of the pattern A shown in FIG. 2 will be described with reference to FIGS. 6 to 8. FIG. 6 is a graph showing a dependency of a cutoff wavelength Acc and a bend loss of the polarization maintaining optical fiber of the present disclosure with respect to a refractive index volume V. FIG. 7 is a graph showing the dependency of the bend loss and cutoff wavelength of the polarization maintaining optical fiber of the present disclosure with respect to various MFDs at a wavelength of 1.31 μm (in FIG. 7, described as “MFD dependency”). The upper row of FIG. 7 (in FIG. 7, described as “bend loss−λcc characteristic when MFD is changed”) shows the change of the bend loss with respect to λcc for various MFDs. The lower row of FIG. 7 (described as “λcc min−MFD characteristic” in FIG. 7) shows a change in a cutoff wavelength λcc_min with respect to the MFD at a wavelength of 1.31 μm. FIG. 8 is a graph showing the dependency of the radius and relative refractive index difference of the core of the polarization maintaining optical fiber of the present disclosure with respect to the MFD.

First, in FIG. 6, a horizontal axis is the refractive index volume V (μm²·%). The refractive index volume V is a value of a product of a total cross-sectional area of six low-refractive-index portions 70A shown as the pattern A among various low-refractive-index portions 70A to 70H shown in FIG. 2 and an absolute value of an average relative refractive index difference of six low-refractive-index portions 70A. The relative refractive index difference of each low-refractive-index portion 70A with respect to common cladding 50 is set to be −1.0% to −0.5%. The upper row of a vertical axis is the cutoff wavelength λcc (μm). The lower row of the vertical axis is the bend loss (dB). The bend loss is a transmission loss measured when light having a wavelength of 1.55 μm is input in a state in which the polarization maintaining optical fiber to be measured is bent once with a bend radius of 5 mm such that each of the pair of stress application portions is parallel to a bent surface.

As can be seen from FIG. 6, the bend loss at the cutoff wavelength Acc and the wavelength of 1.55 μm shows dependency with respect to the refractive index volume V. Each low-refractive-index portion 70A functions as a trench layer, and thus contributes to a reduction in bend loss. In addition, as the refractive index volume V increases, the bend loss decreases, while the cutoff wavelength λcc increases. Thus, in order to limit an increase in the bend loss, it is sufficient that the refractive index volume V is 20 μm²·% or more. On the other hand, when the refractive index volume V exceeds 120 μm²·%, it is difficult to form second through hole 700B for low-refractive-index rod 700A during the manufacturing of the preform, and thus it is sufficient that the refractive index volume V is 120 μm²·% or less. Thus, polarization maintaining optical fiber 10 conforming to the ITU-T standard G.657.B3 is obtained by appropriately selecting the refractive index volume V.

Next, in the upper row of FIG. 7, a horizontal axis is the cutoff wavelength λcc (dB). A vertical axis is the same bend loss (dB) as the lower row of the vertical axis in FIG. 6. In FIG. 7, a graph G710 shows the bend loss−λcc characteristic of a sample having an MFD of 10.2 μm at a wavelength of 1.31 μm. A graph G720 shows the bend loss−λcc characteristic when the MFD is 9.6 μm. A graph G730 shows the bend loss−λcc characteristic of the sample having an MFD of 8.8 μm. A graph G740 shows the bend loss−λcc characteristic of the sample having the MFD of 8.2 μm. The dashed lines shown in the upper row of FIG. 7 show that the bend loss equals 0.15 dB and λcc equals 1.26 μm. In the lower row of FIG. 7, the horizontal axis represents MFD (μm) at a wavelength of 1.31 μm. The vertical axis represents the cutoff wavelength λcc_min (μm) when the bend loss at a wavelength of 1.55 μm is 0.15 dB. The dashed line shown in the lower row of FIG. 7 shows that the cutoff wavelength λcc_min equals 1.26 μm.

As can be seen from the upper and lower rows of FIG. 7, the cutoff wavelength λcc and the bend loss at a wavelength of 1.55 μm shows the dependency with respect to the MFD at a wavelength of 1.31 μm. That is, the smaller the MFD, the stronger the confinement of light and the larger the tolerance, and thus, the smaller the MFD, the larger the tolerance. In particular, as shown in the upper row of FIG. 7, when the MCF is 8.2 μm to 10.2 μm, it is possible to realize a bend loss of less than 0.15 dB at a wavelength of 1.55 μm and the cutoff wavelength λcc of less than 1.26 μm. As shown in the lower row of FIG. 7, when the cutoff wavelength λcc_min (μm) is less than 1.26 μm when the bend loss at a wavelength of 1.55 μm is 0.15 dB, the ITU-T standard G.657.B3 is satisfied. As described above, when the MFD at a wavelength of 1.31 μm is 8.2 μm to 10.2 μm, the cutoff wavelength λcc and the bend loss satisfying the ITU-T standard G.657.B3 can be realized. However, this means that the tolerance satisfying the ITU-T standard G.657.B3 depends on the MFD because the cutoff wavelength λcc and the bend loss have a trade-off relationship.

In FIG. 8, a horizontal axis represents the relative refractive index difference (described as “core A” in FIG. 8) of core 40 with respect to common cladding 50. A vertical axis is the radius a of core 40. In FIG. 8, a graph G810 shows a relationship of core Δ-core radius when the MFD at a wavelength of 1.31 μm is 7 μm. A graph G820 shows the relationship of core Δ-core radius when the MFD is 8 μm. A graph G830 shows the relationship of core Δ-core radius when the MFD is 9 μm. A graph G840 shows the relationship of core Δ-core radius when the MFD is 10 μm. A graph G850 shows the relationship of core Δ-core radius when the MFD is 11 μm. A graph G860 shows the relationship of core Δ-core radius when the MFD is 12 μm. A graph G870 shows the relationship of core Δ-core radius when the MFD is 13 μm.

When the allowable ranges of the core Δ and the core radius are selected for the graph G830 as a reference line among the graphs G810 to G870, as can be seen from FIG. 8, it is sufficient that the radius of core 40 on the cross-section of polarization maintaining optical fiber 10 is within a range of 3 μm to 5 μm. It is sufficient that the relative refractive index difference of core 40 with respect to common cladding 50 is within a range of 0.2% to 0.5%.

As can be understood from the description of the embodiments described above, the present specification also includes the disclosure of the following aspects.

### Appendix 1

A polarization maintaining optical fiber comprising:
a core extending along a fiber axis;
a pair of stress application portions;
one or more low-refractive-index portions; and
a common cladding surrounding the core, the pair of stress application portions, and the one or more low-refractive-index portions,
wherein, on a cross-section of the polarization maintaining optical fiber orthogonal to the fiber axis,
   the pair of stress application portions are disposed one each on two sides of the core in a state of being away from the core with part of the common cladding interposed between each of the pair of stress application portions and the core, and
   the one or more low-refractive-index portions are disposed around the core in a state of being away from each other with part of the common cladding interposed between the one or more low-refractive-index portions and in a state of being away from both the core and the pair of stress application portions with part of the common cladding interposed between each of the one or more low-refractive-index portions and each of the core and the pair of stress application portions.

### Appendix 2

A method for manufacturing the polarization maintaining optical fiber according to any one of claim 1 to claim 7, comprising:
manufacturing an optical fiber preform for obtaining the polarization maintaining optical fiber; and
drawing the optical fiber preform manufactured in the manufacturing of the optical fiber preform,
wherein the manufacturing of the optical fiber preform includes
   preparing a common cladding rod to become part of the common cladding after drawing,
   individually performing preparation of a core rod including a portion to become the core after drawing, preparation of one or more low-refractive-index rods to become the one or more low-refractive-index portions after drawing, and preparation of a pair of stress application rods to become the pair of stress application portions after drawing,
   individually performing, with respect to the common cladding rod, formation of a first through hole into which the core rod is to be inserted, formation of one or more second through holes into which the one or more low-refractive-index rods are to be individually inserted, and formation of a pair of third through holes into which the pair of stress application rods are to be individually inserted, and
   individually performing integration of the common cladding rod and the core rod, integration of the common cladding rod and the one or more low-refractive-index rods, and integration of the common cladding and the pair of stress application rods, and
wherein, in the optical fiber preform, the core rod, each of the one or more low-refractive-index rods, and each of the pair of stress application rods are disposed in a state of being physically away from each other with part of the common cladding rod interposed among the core rod, the one or more low-refractive-index rods, and the pair of stress application rods.

### REFERENCE SIGNS LIST

10 polarization maintaining optical fiber
20 glass optical fiber
30 resin coat
40 core
50 common cladding
60A, 60B stress application portion
70A to 70H low-refractive-index portion
100A common cladding rod
100B intermediate preform
100C optical fiber preform
200 heater
300 resin coating device
400A core rod
400B first through hole
401 core portion
402 cladding inner side portion
403 cladding outer side portion
410 roller
420 winding device
600A, 600B stress application rod
610A, 610B third through hole
700A low-refractive-index rod
700B second through hole
S arrow

What is claimed is:

1. A polarization maintaining optical fiber comprising:
a core extending along a fiber axis;
a pair of stress application portions;
one or a plurality of low-refractive-index portions; and
a common cladding surrounding the core, the pair of stress application portions, and the one or each of the plurality of low-refractive-index portions,
wherein, on a cross-section of the polarization maintaining optical fiber orthogonal to the fiber axis,
the common cladding is disposed between each of the pair of stress application portions and the core,
the pair of stress application portions are disposed one each on two sides of the core in a state of being away from the core,
the common cladding is disposed between the plurality of low-refractive-index portions,
the plurality of low-refractive-index portions are disposed in a state of being away from each other,
the common cladding is disposed between the one or each of the plurality of low-refractive-index portions and the core,
the common cladding is disposed between the one or each of the plurality of low-refractive-index portions and each of the pair of stress application portions, and
the one or the plurality of low-refractive-index portions are disposed around the core in a state of being away from both the core and the pair of stress application portions.

2. The polarization maintaining optical fiber according to claim 1,
wherein, on the cross-section, a contour of the one or each of the plurality of low-refractive-index portions has
a shape constituted by only a straight line or straight lines, by only a curved line or curved lines, or by a combination of a straight line or straight lines and a curved line or curved lines.

3. The polarization maintaining optical fiber according to claim 1,
wherein the polarization maintaining optical fiber includes two to six low-refractive-index portions as the one or the plurality of low-refractive-index portions, and
wherein, on the cross-section, the two to six low-refractive-index portions are disposed at respective positions at which center-to-center distances of the two to six low-refractive-index portions from a center of the core are equal to each other, and the two to six low-refractive-index portions are disposed not to overlap either of the pair of stress application portions.

4. The polarization maintaining optical fiber according to claim 1,
wherein, on the cross-section, each of the pair of stress application portions has an outside diameter of 30 μm to 40 μm,
wherein a relative refractive index difference of each of the pair of stress application portions with respect to the common cladding is 0.0% or less, and
wherein a ratio a/b_SAP of a radius a of the core to a shortest distance b_SAP from a center of the core to a contour of each of the pair of stress application portions is 0.4 to 0.6.

5. The polarization maintaining optical fiber according to claim
wherein, on the cross-section, a refractive index volume V is 20 μm²·% to 120 μm²·%, the refractive index volume V being defined by a product of a total area of the one or the plurality of low-refractive-index portions and an absolute value of an average value of relative refractive index differences of the one or the plurality of low-refractive-index portions.

6. The polarization maintaining optical fiber according to claim 1,
wherein the polarization maintaining optical fiber has
a mode field diameter of 8.2 μm to 10.2 μm at a wavelength of 1.31 μm,
a bend loss of less than 0.15 dB at a wavelength of 1.55 μm, the bend loss being measured in a state in which the polarization maintaining optical fiber is bent once with a bend radius of 5 mm such that each of the pair of stress application portions is parallel to a bent surface, and
a cutoff wavelength of less than 1.26 μm.

7. The polarization maintaining optical fiber according to claim
wherein, on the cross-section, the core has a radius of 3 μm to 5 μm, and
wherein a relative refractive index difference of the core with respect to the common cladding is 0.2% to 0.5%.

8. A method for manufacturing the polarization maintaining optical fiber according to claim 1, the method comprising:
manufacturing an optical fiber preform for obtaining the polarization maintaining optical fiber; and
drawing the optical fiber preform manufactured in the manufacturing of the optical fiber preform,
wherein the manufacturing of the optical fiber preform includes
preparing a common cladding rod to become part of the common cladding after drawing,
individually performing preparation of a core rod including a portion to become the core after drawing, preparation of one or a plurality of low-refractive-index rods to become the one or the plurality of low-refractive-index portions after drawing, and preparation of a pair of stress application rods to become the pair of stress application portions after drawing,
individually performing, with respect to the common cladding rod, formation of a first through hole into which the core rod is to be inserted, formation of one or a plurality of second through holes into which the one or the plurality of low-refractive-index rods are to be individually inserted, and formation of a pair of third through holes into which the pair of stress application rods are to be individually inserted, and
individually performing integration of the common cladding rod and the core rod, integration of the common cladding rod and the one or the plurality of low-refractive-index rods, and integration of the common cladding rod and the pair of stress application rods, and
wherein, in the optical fiber preform, the common cladding rod is disposed among the core rod, the one or each of the plurality of low-refractive-index rods, and each of the pair of stress application rods.
